(19) United States
(12) Patent Application Publication
(10) Pub. No.: US 2015/0061285 A1
(43) Pub. Date: Mar. 5, 2015

(54) Connecting Structure for Coin Machine

(71) Applicant: Chiu-Ming Chen, Lioujiao Township (TW)

(72) Inventor: Chiu-Ming Chen, Lioujiao Township (TW)

(21) Appl. No.: 14/011,810

(22) Filed: Aug. 28, 2013

(51) Int. Cl. G07F 9/10

(52) U.S. Cl. CPC G07F 9/10
USPC 285/330

(57) ABSTRACT

A connecting structure for a coin machine contains: a receiving funnel including a first main body, a male retaining member, and at least two positioning tabs. The first main body has the male retaining member retaining with a female retaining member and has the at least two positioning tabs. A coin machine includes a second main body, the female retaining member, at least two extending portions, and the at least two limiting recesses. The female retaining member between the second main body and the first main body has the at least two extending portions corresponding to the at least two positioning tabs, each extending portion has a respective one of the at least two limiting recesses. Each positioning tab has a respective one of at least two guiding faces, and the respective one of the at least two limiting recesses has a respective one of at least two tenons.

### FIELD OF THE INVENTION

The present invent relates to a connecting structure for a coin machine in which at least two positioning tabs are securely retained between at least two limiting recesses and at least two tenons by abutting at least two guiding faces against the at least two positioning tabs so that a receiving funnel is connected with a coin machine firmly.

### BACKGROUND OF THE INVENTION

A conventional connecting structure for a coin machine contains a receiving funnel comprised of a first main body, a male retaining member, and at least one positioning tab. The first main body has the male retaining member disposed on an opening of one end thereof, and the male retaining member has the at least one positioning tab arranged around an outer periphery thereof. A coin machine contains a second main body, a female retaining member, and at least one limiting recess. The female retaining member is fixed on a connecting portion of the second main body and the first main body, and the female retaining member has the at least one positioning tab arranged around an outer periphery thereof.

Thereby, the at least one positioning tab is retained in the at least one limiting recess so as to connect the receiving funnel and the coin machine together. However, the at least one position tab of the receiving funnel disengages from the at least one limiting recess after a long period of using time, so the receiving funnel removes from the coin machine easily.

The present invention has arisen to mitigate and/or obviate the afore-described disadvantages.

### SUMMARY OF THE INVENTION

The primary object of the present invention is to provide a connecting structure for a coin machine in which at least two positioning tabs are securely retained between at least two limiting recesses and at least two tenons by abutting at least two guiding faces against the at least two positioning tabs so that a receiving funnel is connected with a coin machine firmly.

To obtain the above objectives, a connecting structure for a coin machine contains:

a receiving funnel including a first main body, a male retaining member, and at least two positioning tabs. The first main body has the male retaining member with an opening, the male retaining member is served to retain with a female retaining member of a coin machine and has the at least two positioning tabs arranged around an outer peripheral side thereof.

The coin machine includes a second main body, the female retaining member, at least two extending portions, and the at least two limiting recesses. The female retaining member is mounted on a connecting portion of the second main body and the first main body, the female retaining member has the at least two extending portions formed around an outer peripheral side thereof and corresponding to the at least two positioning tabs, each extending portion has a respective one of the at least two limiting recesses defined therein.

Each positioning tab has a respective one of at least two guiding faces defined on an end surface thereof, and the respective one of the at least two limiting recesses has a respective one of at least two tenons extending outwardly from one end thereof.

### BRIEF DESCRIPTION OF THE DRAWINGS

FIG. 1 is a perspective view showing the exploded components of a connecting structure for a coin machine according to a preferred embodiment of the present invention.

FIG. 2 is a plan view showing the exploded components of the connecting structure for the coin machine according to the preferred embodiment of the present invention.

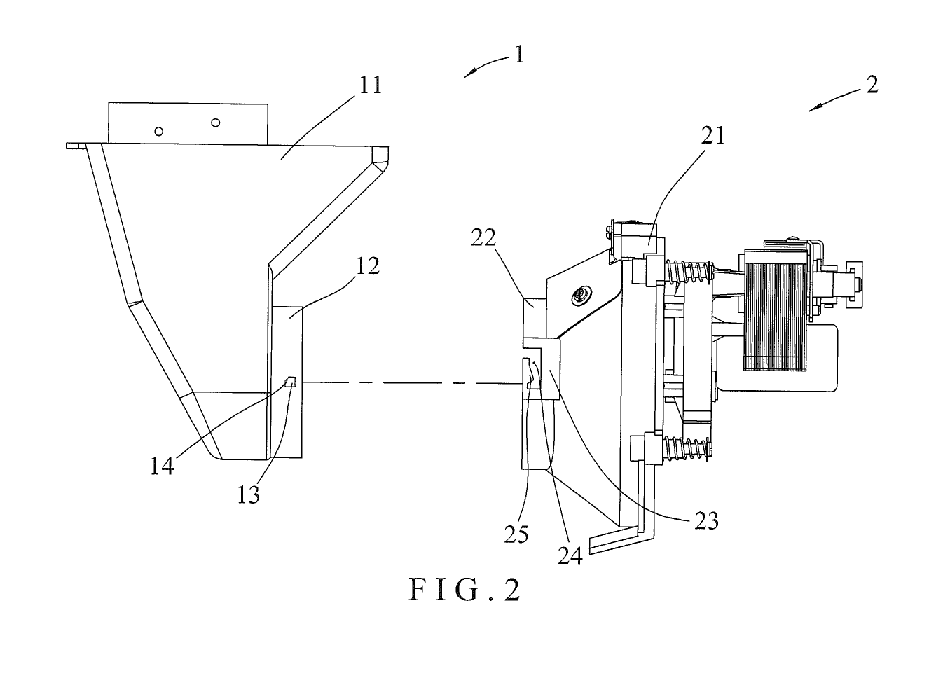

FIG. 3 is a plan view showing a receiving funnel of the connecting structure for the coin machine being rotated according to the preferred embodiment of the present invention.

FIG. 4 is a plan view showing the receiving funnel being connected with the coin machine according to the preferred embodiment of the present invention.

### DETAILED DESCRIPTION OF THE PREFERRED EMBODIMENTS

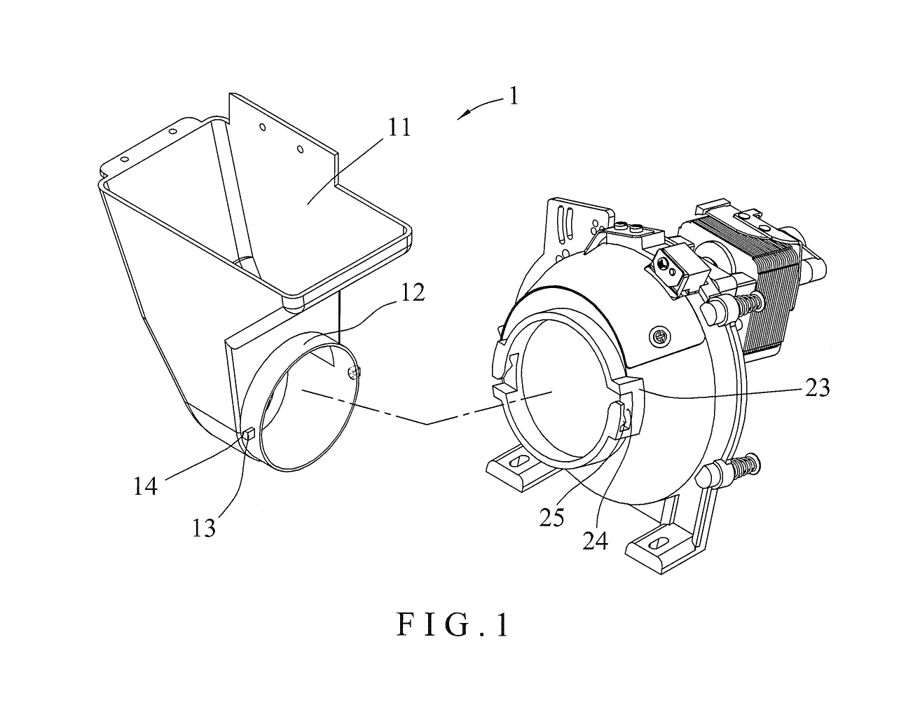

With reference to FIG. 1, a connecting structure for a coin machine according to a preferred embodiment of the present invention comprises: a receiving funnel 1 including a first main body 11, a male retaining member 12, at least two positioning tabs 13, and at least two guiding faces 14. The first main body 11 is used to hold coins and has the male retaining member 12 with an opening, the male retaining member 12 is served to retain with a female retaining member 22 of a coin machine 2 and has the at least two positioning tabs 13 arranged around an outer peripheral side thereof, wherein each positioning tab 13 has a respective one of the at least two guiding faces 14 defined on an end surface thereof so that each positioning tab 13 retains between a respective one of at least two limiting recesses 24 and a respective one of at least two tenons 25 of the coin machine 2.

The coin machine 2 includes a second main body 21, the female retaining member 22, at least two extending portions 23, the at least two limiting recesses 24, and the at least two tenons 25. The second main body 21 is applied to control a supply of coins, and the female retaining member 22 is mounted on a connecting portion of the second main body 21 and the first main body 11, the female retaining member 22 has the at least two extending portions 23 formed around an outer peripheral side thereof and corresponding to the at least two positioning tabs 13, wherein each extending portion 23 has the respective one of the at least two limiting recesses 24 defined therein, and the respective one of the at least two limiting recesses 24 has the respective one of the at least two tenons 25 extending outwardly from one end thereof.

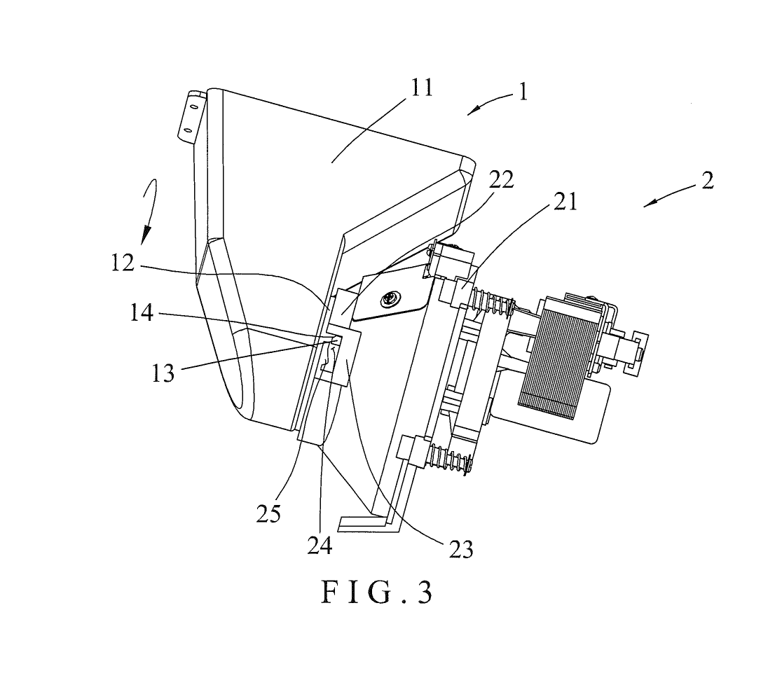

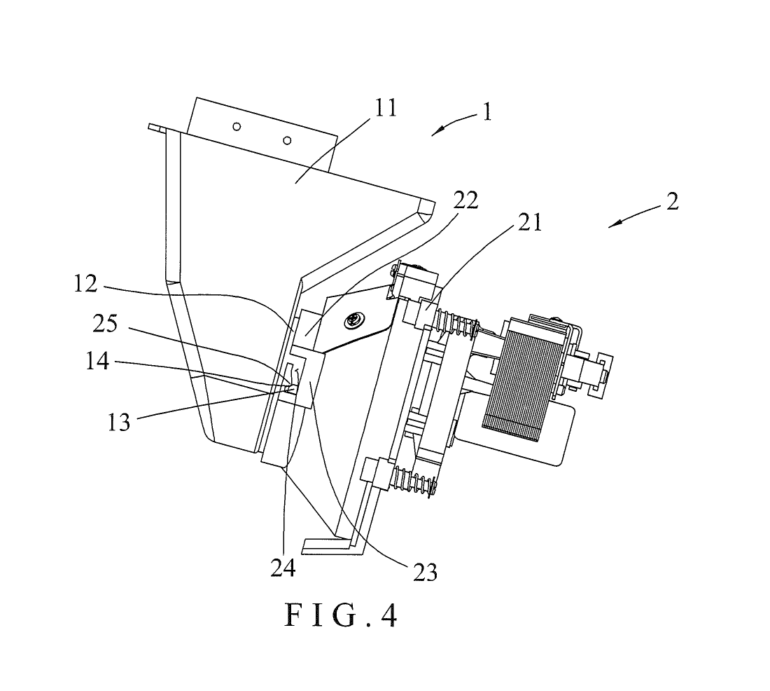

Referring further to FIGS. 3 and 4, in assembly, the male retaining member 12 of the first receiving body 11 is retained with the female retaining member 22 of the second main body 21 so that the at least two positioning tabs 13 are locked into the at least two limiting recesses 24, and then the first main body 11 is rotated so that the at least two guiding faces 14 of the at least two positioning tabs 13 abut against the at least two tenons 25, such that the at least two positioning tabs 13 are retained between the at least two limiting recesses 24 and the at least two tenons 25, hence the at least two positioning tabs 13 and the at least two tenons 25 are fixed securely.

Accordingly, the connecting structure for the coin machine has the following advantage:

The at least two positioning tabs 13 are securely retained between the at least two limiting recesses 24 and the at least two tenons 25 by abutting the at least two guiding faces 14 against the at least two positioning tabs 13 so that the receiving funnel 1 is connected with the coin machine 2 firmly.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A connecting structure for a coin machine comprising:
a receiving funnel including a first main body, a male retaining member, and at least two positioning tabs, the first main body having the male retaining member with an opening, the male retaining member being served to retain with a female retaining member of a coin machine and having the at least two positioning tabs arranged around an outer peripheral side thereof;
the coin machine including a second main body, the female retaining member, at least two extending portions, and the at least two limiting recesses, the female retaining member being mounted on a connecting portion of the second main body and the first main body, the female retaining member having the at least two extending portions formed around an outer peripheral side thereof and corresponding to the at least two positioning tabs, each extending portion having a respective one of the at least two limiting recesses defined therein;
wherein each positioning tab has a respective one of at least two guiding faces defined on an end surface thereof, and the respective one of the at least two limiting recesses has a respective one of at least two tenons extending outwardly from one end thereof.
